(19) United States
(12) Patent Application Publication
(10) Pub. No.: US 2002/0003853 A1
(43) Pub. Date: Jan. 10, 2002

(54) Method of monitoring inner wall crud of piping inside a nuclear reactor pressure vessel, and inner wall crud sampling apparatus

(75) Inventors: Shigeki Ohno, Hitachinaka (JP); Nobuo Tada, Mito (JP); Minoru Maeda, Hitachi (JP)

Correspondence Address: CROWELL & MORING, L.L.P., 1200 G Street, N.W., Suite 700, Washington, DC, 20005, US

(73) Assignee: Hitachi, Ltd.

(21) Appl. No.: 09/931,410

(22) Filed: Aug. 17, 2001

(30) Foreign Application Priority Data
Feb. 28, 2000 (JP) 2000-050890

(51) Int. Cl. G21C 19/42

(52) U.S. Cl. 376/310

(57) ABSTRACT

An inlet mixer from a diffuser installed inside a nuclear reactor pressure vessel is removed, crud from a inner wall surface of the tubular portion of said removed inlet mixer or said installed diffuser is scraped off remotely in water, and said scraped crud is retrieved and monitored.

### BACKGROUND OF THE INVENTION

The present invention relates to a monitoring method of crud adhering to the inner wall surface of the piping inside a nuclear reactor pressure vessel, and an apparatus for sampling the crud.

As is disclosed in Japanese Patent translation of PCT international publication No. H9-502533, there exists a technology of injecting precious metal compounds such as zirconium or the like into the cooling water to adhere the same on the surface of the structures, in order to restrain corrosion of structures inside a nuclear reactor.

On the other hand, as is disclosed in Japanese Patent Laid-Open No. H9-292486, an apparatus for sampling crud remotely from the branch pipe of the target piping is proposed as an apparatus for sampling crud such as crud or the like adhering to the piping of a nuclear power facility with fluid running therein.

With the above-mentioned prior art, sensibility towards stress-corrosion cracking could be reduced, when precious metals such as zirconium, palladium, platinum, rhodium, titanium or the like adhere to the vicinity of the welding heat-affected zone. However, the effect decreases unless a certain amount of the metal adheres to the area. Therefore, it is essential to maintain a considerable amount of crud.

Zirconium or the like injected inside the cooling water does not adhere well at places with fast current. Also, there is a fear that crud might exfoliate at places with fast current during operation. Therefore, it is desirable to monitor the amount of crud at places with fast current inside the nuclear reactor. However, there had been no crud monitoring method of the structures inside the nuclear reactor proposed heretofore.

On the other hand, the conventional crud sampling apparatus inside the piping mentioned above is designed to sample crud from the inner side of the piping which is installed in air, and is provided with a branch pipe. It is not designed to sample crud from equipment piping and the like installed in water, such as a jet pump inside a nuclear reactor pressure vessel, or piping which cannot have the sampling apparatus installed to its interior, such as those without branch pipes, or those provided with branch pipes having small diameter, and the like.

Also, with the conventional technique mentioned above, there exist the problem, such as the fact that because a wire brush larger than the inner diameter of the branch pipe cannot be inserted into the piping, crud of the inner side of the piping cannot appropriately be sampled, or not enough crud for performing microanalysis could be sampled, and the like.

### SUMMARY OF THE INVENTION

The object of the present invention is to provide a method of monitoring the amount of inner wall crud necessary for analysis by sampling the crud of the inner wall surface of the piping inside the nuclear reactor pressure vessel remotely in water, and an apparatus for sampling the same.

In a nuclear reactor pressure vessel, the current becomes the fastest inside the jet pump, so that the amount of crud of zirconium in this area becomes small, and there is a fear of exfoliation. The jet pump inlet mixer could be taken out from the nuclear reactor pressure vessel by removing the support at its upper portion.

Therefore, in order to achieve the above-mentioned object, the amount of crud is monitored by approaching the apparatus to the inner surface of an inlet mixer or to the inner surface of a diffuser by removing the inlet mixer, and sampling the necessary amount of crud for analysis by scraping the inner surface thereof and the like. Also, because there exists a plurality of jet pumps, data related to lapse of time could be monitored from the adhering period of crud, by sampling crud from a different jet pump at a different period.

Specifically, the present invention provides a method comprising removing an inlet mixer from a diffuser installed inside a nuclear reactor pressure vessel, inserting a brush into tubular interior of the removed inlet mixer or the installed diffuser remotely in water, scraping off the inner wall crud by contacting the brush against a wall surface of the tubular interior and rotating the brush in the circumferential direction, sucking out the scraped crud along with water via a filter, and monitoring the inner wall crud retrieved by the filter.

Also, the above object could be achieved by an inner wall crud sampling apparatus for piping inside a nuclear reactor pressure vessel, comprising a rack for resting in water an inlet mixer removed from its installed position inside a nuclear reactor pressure vessel, a crud scraping means inserted from a lower end opening of the inlet mixer rested on the rack for scraping off crud of inner wall surface of the tubular portion, and a crud retrieving means for retrieving crud scraped off by the crud scraping means.

Moreover, the above object could also be achieved by an inner wall crud sampling apparatus for piping inside a nuclear reactor pressure vessel, comprising a pole inserted into a tubular interior of a diffuser inside a nuclear reactor pressure vessel with an inlet mixer removed, a pole fixing means for fixing the pole inside the diffuser, a scraping means supported by the pole for scraping off crud of inner wall surface of the tubular portion of the diffuser, and a retrieving means for retrieving crud scraped off by the scraping means.

### BRIEF DESCRIPTION OF THE DRAWINGS

FIG. 1 is a detailed view indicating the monitoring apparatus of the crud of the inner wall surface of the inlet mixer;

FIG. 2 is a structural view indicating the situation where the inlet mixer is removed;

FIG. 3 is a structural view indicating the situation where the inlet mixer is installed on the crud sampling apparatus;

FIG. 4 is a cross-sectional view of the interior of the nuclear reactor pressure vessel;

FIG. 5 is a detailed view indicating the monitoring apparatus of the crud of the inner wall surface of the diffuser; and

FIG. 6 is a drawing indicating the flow of the scheduled check according to the present invention.

### DETAILED DESCRIPTION OF PREFERRED EMBODIMENTS

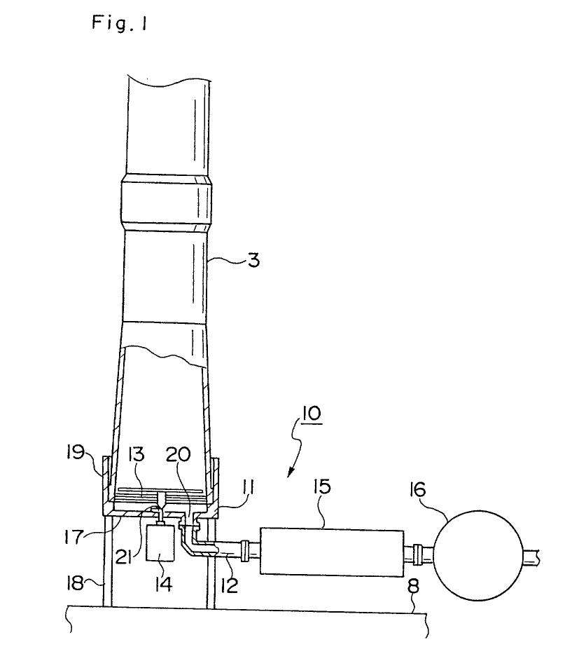

The embodiments of the present invention will now be described with reference to the drawings. The identical structural portions in FIG. 1 through FIG. 5 indicating the apparatus of the present invention are allotted identical reference numbers.

### Embodiment 1

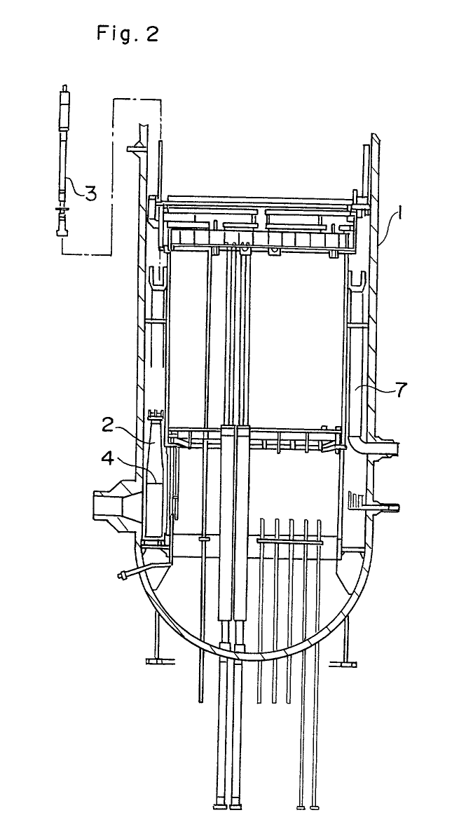

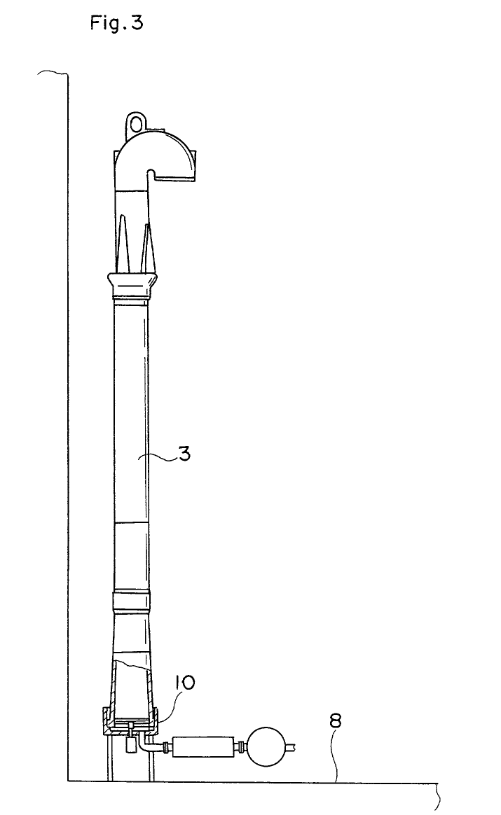

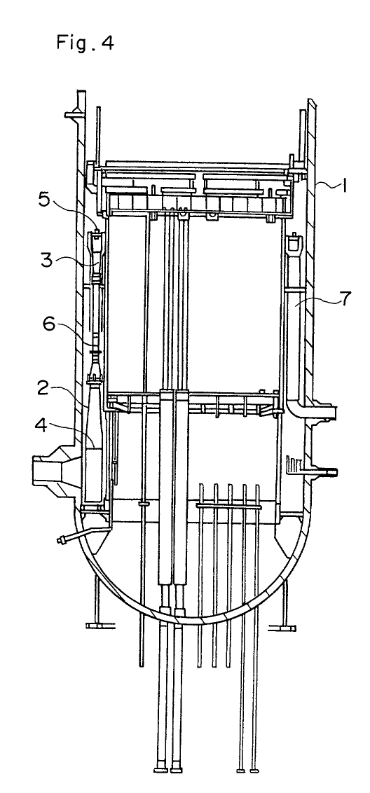

The first embodiment of the present invention will be described with reference to FIG. 1 through FIG. 4. FIG. 1 shows the inner wall crud sampling apparatus for the inlet mixer. FIG. 2 and FIG. 3 are structural views indicating the sampling operation in order. FIG. 4 is a cross-sectional view of a nuclear reactor pressure vessel being the object of the method of the present invention.

First, as is shown in FIG. 4, a jet pump 2 for performing forced circulation of the cooling water is installed inside the nuclear reactor pressure vessel 1. The jet pump 2 is constituted from an inlet mixer 3, a riser pipe 7, a diffuser 4 and the like.

The inlet mixer 3 could be removed from its installed position by removing a jet pump beam 5 and a wedge 6. The inlet mixer 3 may be removed by loosening the jet pump beam 5, and removing the wedge 6, according to the structure of the inlet mixer 3.

In the present embodiment, the jet pump beam 5 and the wedge 6 are removed first, and then the inlet mixer 3 is removed, as is shown in FIG. 2. Next, as is shown in FIG. 3, the removed inlet mixer 3 is installed to a sampling apparatus 10 provided to a reactor well 8. The sampling apparatus 10 may be provided to a drier separator pool or a nuclear waste pool.

The sampling apparatus 10 according to the present invention is constituted from a rack 11, a suction pipe 12, a brush 13, a motor 14, a filter 15, and a pump 16 or the like, as is shown in FIG. 1. Next, the structural relationship of the components and their operation will be described.

The rack 11 is constituted from a plate 17 for resting the inlet mixer 3, and a rigid frame 18 for supporting the same. The plate 17 is provided with an inlet mixer support for inlet mixer of jet pump 19, a suction port 20 for sucking out water or scraped crud and the like, and a brush driving shaft 21 or the like.

The suction port 20 is connected with the suction pipe 12, and is provided with the filter 15 for retrieving the sucked crud, or the suction pump 16. The brush 13 may be formed in a size enabling abrasion of a predetermined area at once, or so as to abrade a predetermined area of the inner wall surface stepwise by providing an elevating function.

After installing the inlet mixer 3 on the rack 11 of the sampling apparatus 10, the pump 16 is driven to suck out the water inside the inlet mixer 3 via the filter 15. At the same time, the motor 14 is driven to rotate the brush 13. The height of the brush 13 is determined so as to enable sampling of the crud necessary for analysis, securing the contact area between the brush 13 and the inlet mixer 3.

The crud scraped off by the brush 13 is sucked out by the pump 16 together with water, and is retrieved by the filter 15. The brush 13 may be provided with an elevating function, in order to secure a predetermined amount of sampling area of the crud. After stopping the rotation of the brush 13, the operation of the pump 16 is stopped, and the filter 15 sampling the crud is retrieved.

When necessary, the surface area of the region exfoliated of the crud by the brush 13 is confirmed using a vernier caliper, light, camera and the like, after sampling is completed. These components may be associated with the sampling apparatus. After completing the sampling operation, the inlet mixer 3 is restored.

### Embodiment 2

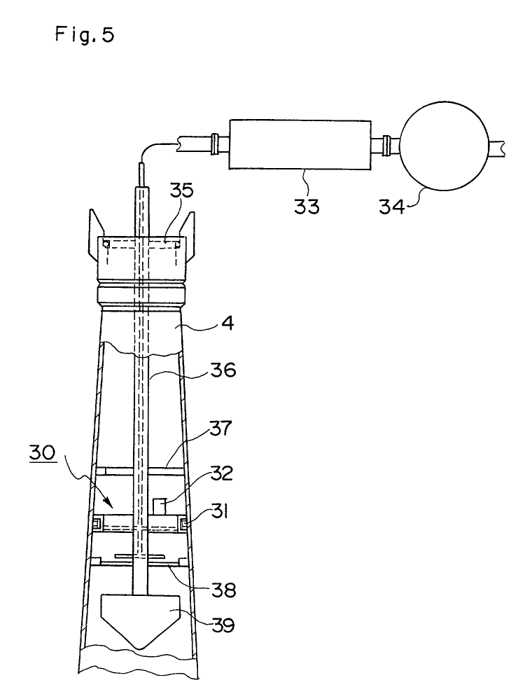

Next, the second embodiment of the present invention will be described with reference to FIG. 5. In order to sample crud of the inner surface of the diffuser 4, the inlet mixer 3 is removed, as is the same as the process stated in Embodiment 1. Next, a sampling apparatus 30 shown in FIG. 5 is installed by inserting from the opening at the upper end of the diffuser 4.

The sampling apparatus 30 is constituted from a brush 31, a motor 32, a filter 33, a pump 34, a supporting plate 35, a hollow pole 36, a horizontal supporting beam 37, and a sheet for collecting crud 38 and the like. Next, the structural relationship of the components and their operation will be described.

The hollow pole 36 of the sampling apparatus 30 is inserted from the opening at the upper end of the diffuser 4, and the supporting plate 35 is fitted with the upper end opening of the diffuser 4 to seat the same. The leading end of the pole 36 is provided with a guide 39 to improve inserting ability. The pole 36 is mounted with the brush 31, which is driven by the motor 32 to scrape off the inner wall crud of the diffuser 4.

By changing the mounting position/of the brush 31 to the pole 36, sampling of the crud at a voluntary height becomes possible. Scraped crud is sucked out within the hollow pole 36 along with water, and is retrieved by the filter 33. The pump 34 sucks out the crud with water via the filter 33.

Also, the pole 36 is provided with the horizontal supporting beam 37 and the sheet for collecting crud 38. By operating the cylinder of the horizontal supporting beam 37 with water pressure or air pressure to brace a plurality of supporting beams inside the diffuser 4, the sampling apparatus 30 is fixed. After completing fixing of the sampling apparatus 30, air is injected to the outer periphery of the sheet for collecting crud 38 to expand the same, so that the sheet comes into close contact with the inner surface of the diffuser 4.

After installing the sampling apparatus 30, the motor 32 is operated, the brush 31 is rotated, and the inner wall crud of the diffuser 4 is exfoliated. The exfoliated crud is sucked out within the hollow pole 36 along with water by the pump 34, and is retrieved by the filter 33. After sufficiently retrieving the exfoliated crud, the rotation of the brush 31 is stopped, and the pump 34 is stopped.

Next, air is removed from the outer periphery of the sheet for collecting crud 38, the bracing of the horizontal support beam 37 is released, the sampling apparatus 30 is removed from the diffuser 4, and the filter 33 sampling the crud is retrieved. Then, the inlet mixer 3 is restored.

### Embodiment 3

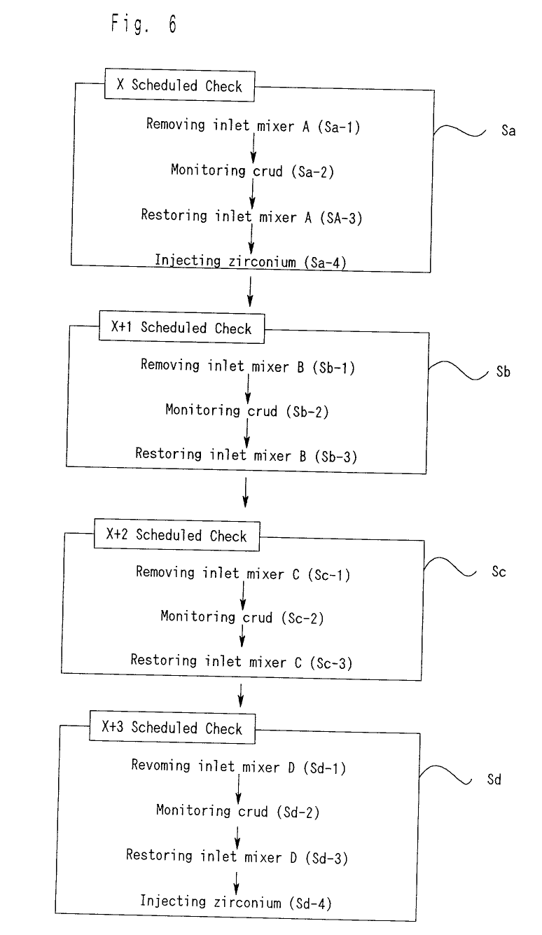

Next, the operation process (step: S) that is the third embodiment of the present invention will be described with reference to FIG. 6. In this embodiment, the monitoring of the crud is carried out at each scheduled check, as is shown in FIG. 6.

Also, by changing the position of the inlet mixer to be removed at each scheduled check, and changing the sampling position of the crud, the variation of the amount of crud per lapse of time is monitored. When a predetermined amount of zirconium or the like is not adhered as a result of the monitoring, zirconium or the like is reinjected.

First, in a scheduled check No. X (Sa), a predetermined single inlet mixer A is removed (Sa-1), the crud adhered to the inner surface of the inlet mixer or the diffuser is sampled, and qualitative and quantitative analysis of the crud is carried out (Sa-2). After the operation, the inlet mixer A is restored (Sa-3), and a predetermined amount of zirconium is injected based on the analysis result (Sa-4).

At the next scheduled check No. X+1 (Sb), a single inlet mixer B positioned differently from the previous case is removed (Sb-1), the crud adhered to the inner surface of the inlet mixer or the diffuser is sampled, and qualitative and quantitative analysis of the crud is carried out (Sb-2). After the operation, the inlet mixer B is restored (Sb-3), and no injection of zirconium is carried out in this case, based on the analysis result showing sufficient amount of crud (Sb-4).

At the next scheduled check No. X+2 (Sc), a single inlet mixer C positioned differently from the previous case is removed (Sc-1), analysis is carried out as is in the previous case (Sc-2), and the inlet mixer C is restored (Sc-3). No injection of zirconium is carried out, because amount of crud is maintained as is in the previous case (Sc-4).

At the next scheduled check No. X+3 (Sd), yet another single inlet mixer D positioned different from the previous case is removed (Sd-1), the crud adhered to the inner surface of the inlet mixer or the diffuser is sampled, and qualitative and quantitative analysis of the crud is carried out (Sd-2). After the operation, the inlet mixer D is restored (Sd-3), and a predetermined amount of zirconium is injected based on the analysis result (Sd-4).

As is seen from the present embodiment, sampling of the crud may not necessarily be carried out at each scheduled check. It may be carried out at every few scheduled checks. Also, monitoring may not be limited to one location, but may be performed simultaneously to a plurality of locations. Moreover, though zirconium is injected once every three scheduled checks in the present embodiment, it goes without saying that this is solely based on the result of monitoring.

We claim:

1. A method of monitoring inner wall crud of piping inside a nuclear reactor pressure vessel, comprising:
removing an inlet mixer from a diffuser installed inside the nuclear reactor pressure vessel;
scraping off crud from an inner wall surface of the tubular portion of said removed inlet mixer or said installed diffuser remotely in water; and
retrieving and monitoring said scraped crud.

2. A method of monitoring inner wall crud of piping inside a nuclear reactor pressure vessel, comprising:
removing an inlet mixer from a diffuser installed inside the nuclear reactor pressure vessel;
inserting a brush into a tubular interior of said removed inlet mixer or said installed diffuser remotely in water;
scraping off inner wall crud by contacting said brush against a wall of said tubular interior and rotating said brush in the circumferential direction;
sucking out said scraped crud along with water via a filter; and
monitoring said inner wall crud retrieved by said filter.

3. A method of monitoring inner wall crud according to claim 1 or 2, wherein said crud sampled from said inner wall surface of said inlet mixer or said diffuser is monitored as needed by removing one or a plurality of inlet mixers at each scheduled check or at every few scheduled checks of said nuclear reactor pressure vessel.

4. An inner wall crud sampling apparatus for piping inside a nuclear reactor pressure vessel, comprising:
a rack for resting in water an inlet mixer removed from an installed position inside the nuclear reactor pressure vessel;
a crud scraping means inserted from a lower end opening of said inlet mixer rested on said rack for scraping off crud of an inner wall surface of the tubular portion; and
a crud retrieving means for retrieving crud scraped off by said crud scraping means.

5. An inner wall crud sampling apparatus according to claim 4, wherein said rack is installed to any of a reactor well, a drier separator pool, or a nuclear waste pool.

6. An inner wall crud sampling apparatus for piping inside a nuclear reactor pressure vessel, comprising:
a pole inserted into a tubular interior of a diffuser inside the nuclear reactor pressure vessel with an inlet mixer removed;
a pole fixing means for fixing said pole inside said diffuser;
a scraping means supported by said pole for scraping off crud of an inner wall surface of the tubular portion of said diffuser; and
a retrieving means for retrieving crud scraped by said scraping means.

7. An inner wall crud sampling apparatus according to claim 6, wherein said pole fixing means includes a supporting beam mounted to said pole, said beam being capable of pressing inner wall surfaces of said diffuser by expanding in a horizontal direction.

8. An inner wall crud sampling apparatus according to claim 6, wherein said pole includes at a leading end thereof a guide for inserting into said diffuser.

9. An inner wall crud sampling apparatus according to claim 6, wherein said pole is equipped with a sheet for collecting falling crud scraped from said inner wall surface of said diffuser, and said sheet is constituted so as to closely contact a sheet outer peripheral portion being expanded by air injection against said inner wall surface of said diffuser.

10. An inner wall crud sampling apparatus according to claim 6, wherein said pole has a hollow tubular structure, and is constituted so that said scraped crud is transferred inside said hollow tube along with water.

11. An inner wall crud sampling apparatus according to claim 4 or 6, wherein said crud scraping means includes a brush contacting against said inner wall surface and rotating in the circumferential direction.

12. An inner wall crud sampling apparatus according to claim 11, wherein said brush is constituted so as to scrape a predetermined area of said inner wall surface stepwise, by being equipped with an elevating function.

13. An inner wall crud sampling apparatus according to claim 4 or 6, wherein said crud retrieving means includes a filter, and also includes a pump for sucking out said scraped crud from said inner wall surface along with water.

14. An inner wall crud sampling apparatus according to claim 4 or 6, wherein said apparatus is equipped with a confirming means for confirming the surface area with crud scraped off by said crud scraping means.
